(19) United States
(12) Patent Application Publication
(10) Pub. No.: US 2018/0186190 A1
(43) Pub. Date: Jul. 5, 2018

(54) TIRE COMPRISING THREE WORKING LAYERS

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Agnes DeGeorges, Clermont-Ferrand (FR); Aurore Lardjane, Clermont-Ferrand (FR); Laurence Lapra, Clermont-Ferrand (FR); David Fraux, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/740,027

(22) PCT Filed: Jun. 20, 2016
(86) PCT No.: PCT/EP2016/064230

§ 371 Date: Dec. 27, 2017

(30) Foreign Application Priority Data
Jul. 3, 2015 (FR) 1556314

(51) Int. Cl. B60C 9/20; B60C 9/28; B60C 9/00

(52) U.S. Cl. CPC B60C 9/2006; B60C 9/28; B60C 9/185; B60C 2009/2051; B60C 2009/209; B60C 9/0007

(57) ABSTRACT

The tire includes a crown reinforcement which is formed of three working crown layers of reinforcing elements. The reinforcing elements of the two radially outermost working layers are crossed from one layer to the other, making with the circumferential direction angles of between 20 and 45° the circumferential direction, of the reinforcing elements of the radially innermost working layer being between 15 and 20°. The reinforcing elements of the two radially innermost working layers are oriented in the same direction with respect to the circumferential direction. The difference between the angles of the reinforcing elements of the radially innermost working layers is greater than 10°. The widths of the two radially outermost working layers are greater than the 0.7 times the width of the tread, and the width of the radially innermost working layer is strictly less than 0.7 times the width of the tread.

### CROSS-REFERENCE TO RELATED APPLICATION

The present application claims priority to PCT International Patent Application Serial No. PCT/EP2016/064230, filed Jun. 20, 2016, entitled “TIRE COMPRISING THREE WORKING LAYERS,” which claims the benefit of FR Patent Application Serial No. 1556314, filed Jul. 3, 2015.

### BACKGROUND OF THE INVENTION

### 1. Field of the Invention

The present disclosure relates to a tire having a radial carcass reinforcement, and more particularly a tire intended for fitting to vehicles that carry heavy loads, such as lorries, tractors, trailers or buses, for example.

### 2. Related Art

In the tires of heavy duty type, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. The working layers that form the working reinforcement may furthermore be covered with at least one layer, referred to as a protective layer, formed of reinforcing elements which are advantageously metallic and extensible and referred to as elastic reinforcing elements. It may also comprise a layer of metal threads or cords having low extensibility, forming an angle of between 45° and 90° with the circumferential direction, this ply, referred to as the triangulation ply, being located radially between the carcass reinforcement and the first crown ply, referred to as the working ply, which are formed of parallel threads or cords lying at angles not exceeding 45° in terms of absolute value. The triangulation ply forms a triangulated reinforcement with at least the working ply, this reinforcement exhibiting little deformation under the various stresses to which it is subjected, the triangulation ply essentially serving to react the transverse compressive forces to which all the reinforcing elements in the crown region of the tire are subjected.

Cords are said to be inextensible when the cords exhibit, under a tensile force equal to 10% of the breaking force, a relative elongation at most equal to 0.2%.

Cords are said to be elastic when the cords exhibit, under a tensile force equal to the breaking load, a relative elongation at least equal to 3% with a maximum tangent modulus of less than 150 GPa.

Circumferential reinforcing elements are reinforcing elements which form angles with the circumferential direction in the range +2.5°, −2.5° around 0°.

The circumferential direction of the tire, or longitudinal direction, is the direction that corresponds to the periphery of the tire and is defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

For metal wires or cords, force at break (maximum load in N), breaking strength (in MPa) and elongation at break (total elongation in %) are measured under tension in accordance with standard ISO 6892, 1984.

Certain present-day tires, referred to as “road tires”, are intended to run at high average speeds and over increasingly long journeys, because of improvements to the road network and the growth of motorway networks worldwide. The combined conditions under which such a tire is called upon to run undoubtedly make it possible to increase the distance covered, since tire wear is lower. This increase in life in terms of distance covered, combined with the fact that such conditions of use are likely, under heavy load, to result in relatively high crown temperatures, dictates the need for an at least proportional increase in the durability of the crown reinforcement of the tires.

This is because stresses are present in the crown reinforcement; more particularly, there are shear stresses between the crown layers which, in the case of an excessive rise in the operating temperature at the ends of the axially shortest crown layer, result in the appearance and propagation of cracks in the rubber at the ends. The same problem exists in the case of edges of two layers of reinforcing elements, the other layer not necessarily being radially adjacent to the first layer.

In order to improve the endurance of the crown reinforcement of the tires, the French application FR 2 728 510 proposes arranging, on the one hand, between the carcass reinforcement and the crown reinforcement working ply that is radially closest to the axis of rotation, an axially continuous ply which is formed of inextensible metal cords that form an angle at least equal to 60° with the circumferential direction and of which the axial width is at least equal to the axial width of the shortest working crown ply and, on the other hand, between the two working crown plies, an additional ply formed of metal elements that are oriented substantially parallel to the circumferential direction.

In addition, the French application WO 99/24269 notably proposes, on each side of the equatorial plane and in the immediate axial continuation of the additional ply of reinforcing elements substantially parallel to the circumferential direction, that the two working crown plies formed of reinforcing elements crossed from one ply to the next be coupled over a certain axial distance and then uncoupled using profiled elements of rubber compound over at least the remainder of the width that the two working plies have in common.

The layer of circumferential reinforcing elements is usually made up of at least one metal cord wound to form a turn of which the angle of layering with respect to the circumferential direction is less than 8°. The cords initially manufactured are coated with a rubber compound before being laid. This rubber compound will then penetrate the cord under the effect of the pressure and temperature during the curing of the tire.

The results thus obtained in terms of endurance and wear in the case of prolonged road running at high speed are usually satisfactory. However, it would seem that, under certain running conditions, certain tires sometimes exhibit more pronounced wear on a part of their tread. This phenomenon is accentuated when the width of the tread increases.

Moreover, whatever the envisaged solutions such as those set out above, the presence of a layer of additional reinforcing elements results in a greater mass of the tire and higher tire manufacturing costs.

Document WO 10/069676 proposes a layer of circumferential reinforcing elements distributed at a variable spacing. Depending on the spacings chosen, more widely spaced in the central and intermediate parts of the layer of circumferential reinforcing elements, it is possible to create tires that have satisfactory performance in terms of endurance with improved performance in terms of wear. Moreover, compared with a tire comprising a layer of circumferential reinforcing elements distributed at a constant spacing, it is possible to reduce the mass and cost of such tires, even though it is necessary to make up for the absence of reinforcing elements by using masses of polymer.

Moreover, the use of tires on heavy duty vehicles of the “worksite supply” type means that the tires are subjected to shocks when running over stony ground. These shocks are of course detrimental in terms of performance, and notably in terms of endurance.

### SUMMARY OF THE INVENTION AND ADVANTAGES

One object of the present disclosure is to provide tires for “heavy goods” vehicles of the “worksite supply” type in which the performance in terms of wear is retained and the performance in terms of endurance is improved, notably with regard to the shocks experienced when running over stony ground.

This objective is achieved according to the disclosure by a tire with a radial carcass reinforcement for a vehicle of the heavy duty type comprising a crown reinforcement comprising three working crown layers of reinforcing elements, itself capped radially by a tread, the tread being connected to two beads by two sidewalls, the reinforcing elements of the two radially outermost working layers being crossed from one layer to the other, making with the circumferential direction angles of between 20 and 45°, the angles, formed with the circumferential direction, of the reinforcing elements of the radially innermost working layer being between 15 and 20°, the reinforcing elements of the two radially innermost working layers being oriented in the same direction with respect to the circumferential direction, the difference between the angles of the reinforcing elements of the radially innermost working layers being greater than 10°, the widths of the two radially outermost working layers being greater than 0.7 times the width of the tread, and the width of the radially innermost working layer being strictly less than 0.7 times the width of the tread.

For preference according to the disclosure, the difference between the absolute values of the angles of the reinforcing elements of the radially outermost working layers is greater than 45°.

The axial widths of the layers of reinforcing elements are measured on a cross section of a tire, the tire therefore being in an uninflated state.

The axial width of the tread is measured between two shoulder ends when the tire is mounted on its service rim and inflated to its nominal pressure.

A shoulder end is defined, in the shoulder region of the tire, by the orthogonal projection onto the exterior surface of the tire of the intersection of the tangents to the surfaces of an axially external end of the tread (top of the tread patterns) on the one hand and of the radially external end of a sidewall on the other.

According to the disclosure, angles are measured at the circumferential midplane.

The results obtained with tires according to the disclosure have effectively demonstrated that performance in terms of endurance is improved regarding the results observed when running over stony ground.

The inventors have been able to demonstrate that combining the three working plies according to the disclosure makes it possible to make the crown more flexible, therefore encouraging an improvement in endurance performance particularly during running of the “worksite supply” type. Specifically, by comparison with more conventional architectures of this type of tire, the presence of a radially innermost working layer the reinforcing elements of which are oriented in the same direction as the reinforcing elements of the working layer radially in contact therewith with a smaller angle formed with the circumferential direction makes it possible to significantly reduce the stresses experienced by the radially outermost working layers. Furthermore, the width of this, radially innermost, working layer, that is smaller than the width of the other two layers makes it possible to avoid any risk of cleavage at its ends.

The inventors thus propose two radially outermost working layers of which the angles formed between the reinforcing elements and the circumferential direction can be greater than the angles usually applied for the working layers of this type of tire. This opening-up of the angles with respect to the circumferential direction as regards the two radially outermost working layers leads to an increase in the flexibility of the crown of the tire. This increase in flexibility of the crown of the tire, combined with the lowering of the stresses experienced by the two radially outermost layers allows an improvement in endurance performance by comparison with tires of more conventional design.

According to one advantageous alternative form of the disclosure, the reinforcing elements of at least one working layer are cords comprising an internal layer of M internal thread(s) and an external layer of N external threads, the external layer being wound around the internal layer.

For preference, according to this advantageous alternative form of the disclosure, M=1 or 2 and N=5, 6, 7, 8 or 9, for preference M=1 and N=5 or 6, or M=2 and N=7, 8 or 9.

Advantageously too according to this alternative form of the disclosure, at least one of the internal or external threads, preferably each internal and external thread, of each cord of at least one working layer is at least of UHT grade.

Within the meaning of the disclosure, a “thread of at least UHT grade” is a thread exhibiting a mechanical strength at break R expressed in MPa such that R≥4180-2130×D, D being the diameter of the thread expressed in mm.

In other words, advantageously according to this alternative form of the disclosure, at least one of the internal or external threads, preferably each internal and external thread, of each cord of at least one working layer exhibits a mechanical strength at break R expressed in MPa such that R≥4180−2130×D, D being the diameter of the thread expressed in mm.

For preference too, according to the disclosure, at least one of the internal or external threads, preferably each internal and external thread, of each cord of at least one working layer exhibits a mechanical strength at break R expressed in MPa such that R≥4400−2000×D, D being the diameter of the thread expressed in mm.

For preference too according to the disclosure, the reinforcing elements of the three working layers are cords comprising an internal layer of M internal thread(s) and an external layer of N external threads, the external layer being wound around the internal layer, with M=1 or 2 and N=5, 6, 7 or 8, at least one of the internal or external threads of each cord, and preferably each internal and external thread of each cord, exhibiting a mechanical strength at break R expressed in MPa such that R≥4180−2130×D, D being the diameter of the thread expressed in mm.

And for even greater preference according to the disclosure the reinforcing elements of the three working layers are cords comprising an internal layer of M internal thread(s) and an external layer of N external threads, the external layer being wound around the internal layer, with M=1 or 2 and N=5, 6, 7 or 8, at least one of the internal or external threads of each cord, and preferably each internal and external thread of each cord, exhibiting a mechanical strength at break R expressed in MPa such that R≥4400−2000×D, D being the diameter of the thread expressed in mm.

According to these alternative forms of the disclosure, it is possible to create tires that are lightened by comparison with the more conventional tires in which the reinforcing elements have larger diameters.

The inventors have been able to demonstrate that this lightening of the tire is connected with a reduction in the thickness of the crown reinforcement as a result of the reduction in the diameter of the reinforcing elements of the working layers. This reduction in the diameter of the reinforcing elements may also be associated with thicknesses of polymer compound that are reduced by comparison with those of conventional tires and thus with an overall mass of the crown reinforcement that is even further reduced by comparison with that of conventional tires.

The inventors have moreover been able to demonstrate that it is possible to reduce the distances between the reinforcing elements within one and the same working crown layer by comparison with more conventional designs without adversely affecting the endurance properties of the tire. Specifically, it is commonplace to maintain a minimum distance between the reinforcing elements of one and the same working layer so as to limit the phenomena whereby cracks spread from one element to another.

The inventors believe that the presence of three working layers reduces the risks of cracks appearing at the ends of the working layers because of the distribution of stresses between the working layers subjected to cleaving effects. This reduction in the initiation of cracks thus leads to the possibility of reducing the distances between the reinforcing elements.

This reducing of the distances between the reinforcing elements of one and the same working layer moreover contributes to reducing the risk of puncturing of the crown of the tire.

For preference according to the disclosure, the distance between the reinforcing elements, measured along the normal to the direction of the mean line of the thread, is less than 0.80 mm.

According to the disclosure, the distance between the reinforcing elements of a working layer is measured at the circumferential midplane.

The combination of the features of the working layers according to the disclosure, notably of the distance between the reinforcing elements and the diameter thereof, means that the working layers can retain stiffness properties that are sufficient although lower than those of the working layers of a tire of more conventional design, so as to encourage increased flexibility in the crown of the tire.

Advantageously too according to the disclosure, the stiffness per unit width of each of the working crown layers is comprised between 50 and 80 daN/mm.

The stiffness per unit width of a layer of reinforcing elements is determined from measurements taken on the reinforcing elements and from the density of reinforcing elements in the layer, which density is itself defined as the number of reinforcing elements per unit width.

The density measurement is performed by visually counting the number of threads present on a non-deformed sample of fabric with a width of 10 cm. The number of threads counted directly gives the value for the density of the fabric in threads/dm.

According to one advantageous embodiment of the disclosure, a layer of rubber compound is arranged between at least the ends of the two radially outermost working crown layers.

The layer of rubber compound makes it possible to obtain decoupling of the working crown layers so as to spread the shear stresses over a greater thickness. These shear stresses appear notably as a result of circumferential tensions in the contact patch.

Within the meaning of the disclosure, layers that are coupled are layers in which the respective reinforcing elements are separated radially by at most 1.5 mm, the thickness of rubber being measured radially between the respectively upper and lower generatices of the reinforcement elements.

The presence of this layer of rubber compound makes it possible in particular to contribute to limiting the shear stresses between the ends of the working crown layers, the working crown layers having no circumferential stiffness at their ends.

One preferred embodiment of the disclosure also provides for the crown reinforcement to be supplemented radially on the outside by at least one additional layer, referred to as a protective layer, of reinforcing elements which are oriented with respect to the circumferential direction at an angle of between 20° and 45° and in the same direction as the angle formed by the elements of the working layer radially adjacent to it.

According to one embodiment of the disclosure, the reinforcing elements of the protective layer are elastic cords.

Further details and advantageous features of the disclosure will become evident hereinafter from the description of some exemplary embodiments of the disclosure given with reference to the FIGURE which depicts a meridian view of a design of tire according to one embodiment of the disclosure.

### BRIEF DESCRIPTION OF THE DRAWING

In order to make it easier to understand, the FIGURE is not drawn to scale. The FIGURE shows only a half-view of a tire which extends symmetrically about the axis XX′ which represents the circumferential median plane, or equatorial plane, of a tire.

### DETAILED DESCRIPTION OF THE ENABLING EMBODIMENT

In the FIGURE, the tire 1, of size 315/80 R 22.5 Y, has an aspect ratio H/S equal to 0.80, H being the height of the tire 1 on its mounting rim and S being its maximum axial width. The tire 1 comprises a radial carcass reinforcement 2 anchored in two beads, not shown in the FIGURE. The carcass reinforcement 2 is formed of a single layer of metal cords. They further comprise a tread 5.

In the FIGURE, the carcass reinforcement 2 is hooped in accordance with the disclosure by a crown reinforcement 4 formed radially, from the inside to the outside:
of a first working layer 41 formed of metal cords oriented at an angle equal to 18°,
of a second working layer 42 formed of metal cords oriented at an angle equal to 30°,
of a third working layer 43 formed of metal cords oriented at an angle equal to −22°,
of a protective layer 44 formed of E18.23 elastic metal cords parallel to the metal threads of the working layer 43.

The metal cords that make up the reinforcing elements of the three working layers are cords of formula 9.30 of the UHT type having a diameter of 1.23 mm. Threads of SHT type may also be used. They are distributed within each of the working layers with a distance between the reinforcing elements, measured along the normal to the direction of the mean line of the thread, equal to 0.80 mm.

The axial width L₄₁ of the first working layer 41 is equal to 85 mm.

The axial width L₄₂ of the second working layer 42 is equal to 119 mm.

The axial width L₄₃ of the third working layer 43 is equal to 109 mm.

The axial width L₄₄ of the protective layer 44 is equal to 88 mm.

The axial width of the tread, L₅, is equal to 130 mm.

The combined mass of the three working layers 41, 42, 43 and of the protective layer 44, including the mass of the metal cords and of the skim compounds, thus amounts to 5.8 kg.

The tire according to the disclosure is compared against a reference tire of the same size which differs from the tire according to the disclosure in terms of its crown reinforcement which is formed radially, from the inside to the outside:
of a triangulation layer formed of non-wrapped inextensible 9.28 metal cords which are continuous across the entire width of the ply and oriented at an angle equal to 65°,
of a first working layer formed of non-wrapped inextensible 11.35 metal cords which are continuous across the entire width of the ply, oriented at an angle of 26°,
of a second working layer formed of non-wrapped inextensible 11.35 metal cords which are continuous across the entire width of the ply, oriented at an angle of 18° and crossed with the metal cords of the first working layer,
of a protective layer formed of elastic 18.23 metal cords.

The inextensible 11.35 metal cords of the working layers of the reference tire are distributed within each of the working layers with a distance between the reinforcing elements, measured along the normal to the direction of the mean line of the thread, equal to 1 mm.

The combined mass of the working layers of the reference tire, of the protective layer and of the triangulation layer, including the mass of the metal cords and of the skim compounds, amounts to 6.6 kg.

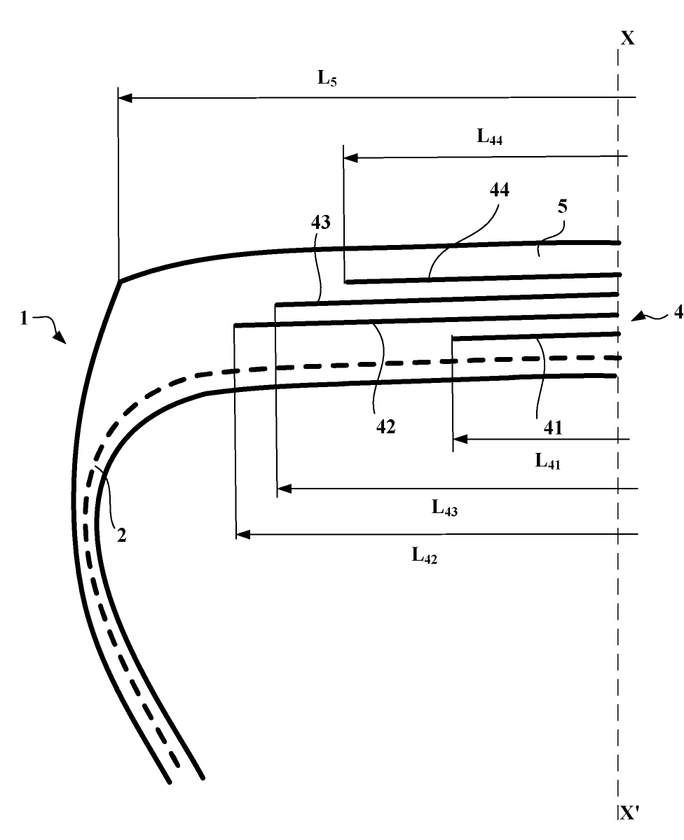

Tests have been conducted with tires produced according to the disclosure as depicted in FIG. 1, and with the reference tire.

First endurance tests were run on a test machine that forced each of the tires to run in a straight line at a speed equal to the maximum speed rating prescribed for the tire (the speed index) under an initial load of 4000 kg progressively increased in order to reduce the duration of the test.

Other endurance tests were conducted on a test machine that cyclically imposed a transverse loading and a dynamic overload on the tires. The tests were carried out for the tires according to the disclosure under conditions identical to those applied to the reference tires.

The tests thus carried out showed that the distances covered during each of these tests are substantially identical for the tires according to the disclosure and the reference tires. It is thus apparent that the tires according to the disclosure exhibit performance in terms of endurance which is substantially the equivalent of that of the reference tires when running on bituminous surfaces.

Three tests aimed at reproducing use of worksite type were also conducted. For each of these tests, the measurements illustrated are referenced to a base 100 for the reference tire.

A first test involved running over an obstacle to simulate the presence of a rock. The values measured correspond to the height of the obstacle, expressed in mm, that causes a breakage of the crown tread block of the tire.

| Reference | 100 |
|---|---|
| Disclosure | >140 |

The test was stopped for the tire according to the disclosure without having observed the slightest loss of pressure.

The second test involved pressing cylindrically shaped polars onto the tread of the tire. The values express the energy required to cause the crown tread block to break. The results are expressed with reference to a base 100 which corresponds to the value measured for the reference tire.

| Reference | 100 |
|---|---|
| Disclosure | 128 |

The third test is a test of crown puncturing by running over an obstacle that simulates the presence of a nail. The values express the range of angles of orientation of the nail with respect to the plane of the ground that carry a risk of puncturing. The smaller the range, the lower the probability of puncturing.

| Reference | 100 |
|---|---|
| Disclosure | 80 |

Regarding this third test, the superiority of the tires according to the disclosure as compared with the reference tires can be interpreted as being due to the fact that the distances between the reinforcing elements of one and the same layer are closer together.

What is claimed is:

1- A tire with a radial carcass reinforcement for a vehicle of the heavy duty type comprising a crown reinforcement comprising three working crown layers of reinforcing elements, itself capped radially by a tread, said tread being connected to two beads by two sidewalls, wherein the reinforcing elements of the two radially outermost working layers are crossed from one layer to the other, making with the circumferential direction angles of between 20 and 45°, in that the angles, formed with the circumferential direction, of the reinforcing elements of the radially innermost working layer are between 15 and 20°, wherein the reinforcing elements of the two radially innermost working layers are oriented in the same direction with respect to the circumferential direction, wherein the difference between the angles of the reinforcing elements of the radially innermost working layers is greater than 10°, wherein the widths of the two radially outermost working layers are greater than 0.7 times the width of the tread, and wherein the width of the radially innermost working layer is strictly less than 0.7 times the width of the tread.

2- The tire according to claim 1, wherein the difference between the absolute values of the angles of the reinforcing elements of the radially outermost working layers is greater than 45°.

3- The tire according to claim 1, wherein the reinforcing elements of at least one working layer are cords comprising an internal layer of M internal thread(s) and an external layer of N external threads, and wherein the external layer is wound around the internal layer.

4- The tire according to claim 3, wherein M=1 or 2 and N=5, 6, 7, 8 or 9.

5- The tire according to claim 3, wherein at least one of the internal or external threads of each cord exhibits a mechanical strength at break R expressed in MPa such that R≥4180−2130×D with D being the diameter of the thread expressed in mm.

6- The tire according to claim 1, wherein the reinforcing elements of the three working layers are cords comprising an internal layer of M internal thread(s) and an external layer of N external threads, the external layer being wound around the internal layer, with M=1 or 2 and N=5, 6, 7 or 8, and wherein at least one of the internal or external threads of each cord exhibits a mechanical strength at break R expressed in MPa such that R≥4180−2130×D with D being the diameter of the thread expressed in mm.

7- The tire according to claim 1, wherein the stiffness per unit width of each of the working crown layers is between 50 and 80 daN/mm.

8- The tire according to claim 1, wherein a layer of rubber compound is arranged between at least the ends of the two radially outermost working crown layers.

9- The tire according to claim 1, wherein the crown reinforcement is supplemented radially on the outside by at least one additional ply, referred to as a protective ply, of reinforcing elements which are oriented with respect to the circumferential direction at an angle of between 20° and 45° and in the same direction as the angle formed by the reinforcing elements of the working crown layer radially adjacent to it.
